(19) United States
(12) Patent Application Publication
(10) Pub. No.: US 2015/0058068 A1
(43) Pub. Date: Feb. 26, 2015

(54) METHODS AND SYSTEMS FOR MANAGING SUPPLIERS AND FLOW OF GOODS ON AN ECOMMERCE PLATFORM

(71) Applicant: TENCENT TECHNOLOGY (SHENZHEN) COMPANY LIMITED, Shenzhen (CN)

(72) Inventors: XUEQING HOU, Shenzhen (CN); HAN GU, Shenzhen (CN); XINYANG HUANG, Shenzhen (CN); JUN XIE, Shenzhen (CN); YANGYAN WANG, Shenzhen (CN); HONGFU GUAN, Shenzhen (CN); ZHENMING CHEN, Shenzhen (CN); YAOHUA TAN, Shenzhen (CN)

(21) Appl. No.: 14/528,423

(22) Filed: Oct. 30, 2014

Related U.S. Application Data
(63) Continuation of application No. PCT/CN2013/088344, filed on Dec. 2, 2013.

(30) Foreign Application Priority Data
Mar. 27, 2013 (CN) 2013-10101337.7

(51) Int. Cl. G06Q 10/06; H04L 29/08

(52) U.S. Cl. CPC G06Q 10/06315; H04L 67/10
USPC 705/7.25

(57) ABSTRACT

A method and system for managing suppliers and flow of goods over an e-commerce platform are disclosed. An exemplary method may include receiving a supply flow change rule, the supply flow change rule includes a condition for change and a supply mode change; and monitoring feedback messages from a supplier regarding transactions associated with a first product. The method may further include determining whether the supplier meets the condition for change with regard to the transaction associated with the first product based on the feedback messages; and changing supply mode for the first product if the supplier meets the condition for change based on the supply mode change. The method and system consistent with the present disclosure may improve the quality of e-commerce services to the users and optimize the performance of the suppliers.

### CROSS-REFERENCES TO RELATED APPLICATIONS

### Related Applications

This application is a continuation application of PCT Patent Application No. PCT/CN2013/088344, filed on Dec. 2, 2013, which is based upon and claims the benefit of priority from Chinese Patent Application No. 201310101337.7, filed on Mar. 27, 2013, the entire contents of all of which are incorporated herein by reference.

### FIELD OF THE INVENTION

The present invention relates to Internet technologies and, more particularly, to methods and systems for managing supplies on e-commerce platforms.

### BACKGROUND

With the development of Internet elated technologies, users can make more and more purchases online. A user may purchase various goods online, including charging his mobile phone (i.e., purchasing minutes of usage), purchasing computer games, game time, or currencies used in computer games. An e-commerce platform may provide one or more types of products to its users. The e-commerce platform may also line up multiple suppliers to provide each product.

In the example of charging mobile phones, a number of suppliers may sell re-charge cards to users. To distribute the orders for mobile phone re-charges, the e-commerce platform may assign a weight ratio to each supplier, and distribute the online orders based on the weight ratios. The flow of the supply ordered from a supplier may be defined by the percentage of online orders distributed to the supplier.

In addition, an e-commerce platform may receive an order from a user to charge his mobile phone. The e-commerce platform may then verify that the user has successfully paid for the order. The e-commerce platform may distribute the order to one of the suppliers who sell mobile phone usage. Based on the flow of the supply defined for each supplier, the e-commerce platform may distribute the order to different suppliers. Thus, a supplier with a larger flow of supply (higher percentage of the total orders) may receive more online orders. Once a supplier receives the order from the e-commerce platform, it may provide the ordered mobile phone minutes and provide feedback to the e-commerce platform. Often, as described in relation to the mobile phone re-charge example, once the flow of supply is determined for each supplier, the e-commerce platform may fail to adjust the flow of supply based on the feedback from the executed transactions.

The disclosed method and system are directed to solve one or more problems set forth above and other problems.

### BRIEF SUMMARY OF THE DISCLOSURE

Embodiments consistent with the present disclosure provide a method, system, terminal device, or a server for managing suppliers and flow of goods. Embodiments consistent with the present disclosure improve the supplier performance on an e-commerce platform.

One aspect of the present disclosure provides a method for managing suppliers and flow of goods over an e-commerce platform. The method includes receiving a supply flow change rule, the supply flow change rule includes a condition for change and a supply mode change; and monitoring feedback messages from a supplier regarding transactions associated with a first product. The method further includes determining whether the supplier meets the condition for change with regard to the transaction associated with the first product based on the feedback messages, and changing the supply mode for the first product if the supplier meets the condition for change based on the supply mode change.

Another aspect of the present disclosure provides a system for managing suppliers and flow of goods over an e-commerce platform. The system includes a receiving unit configured to receive a supply flow change rule, the supply flow change rule includes a condition for change and a supply mode change; and a monitoring unit configured to monitor feedback messages from a supplier regarding transactions associated with a first product. The system further includes a determination unit configured to determine whether the supplier meets the condition for change with regard to the transaction associated with the first product, and an updating unit configured to change the supply mode for the first product if the supplier meets the condition for change based on the supply mode change.

Another aspect of the present disclosure provides a system for managing suppliers and flow of goods over an e-commerce platform. The system includes a receiving unit configured to receive a supply flow change rule, the supply flow change rule includes a condition for change and a supply mode change; and a monitoring unit configured to monitor feedback messages from a supplier, a customer, or a system administrator regarding transactions associated with a first product. The system further includes a determination unit configured to determine whether the supplier meets the condition for change with regard to the transaction associated with the first product based on the feedback messages; and an updating unit configured to change the supply mode for the first product if the supplier meets the condition for change based on the supply mode change.

Another aspect of the present disclosure provides a system for managing suppliers and flow of goods over an e-commerce platform. The system includes a receiving unit configured to receive a re-distribution supply flow change rule, the re-distribution supply flow change rule includes a condition for re-distribution and a re-distribution supply mode change; and a monitoring unit configured to monitor feedback messages from a supplier, a customer, or a system administrator regarding transactions associated with a first product. The system further includes a determination unit configured to determine whether suppliers meet the conditions for re-distribution with regard to the transaction associated with the first product; and an updating unit configured to re-distribute supply flow based on whether the suppliers meet the conditions for re-distribution.

Embodiments consistent with the present disclosure provide a method and system for managing suppliers and flow of goods on an e-commerce platform. The system for managing suppliers and flow of goods may receive supply flow change rules and monitor feedbacks from the suppliers regarding transactions related to a first product. A supply flow change rule may include a condition for change and a corresponding change of supply mode. Based on the feedback, the system may determine whether a supplier's offering of the first product meets the condition for change. If so, the system may adjust the flow from the supplier according to the corresponding mode change. Embodiments consistent with the present disclosure therefore effectively use feedback information, automate the management of the flow of goods, and simplify the management process. Instead of manually adjusting the flow of goods on an e-commerce platform, the embodiments consistent with the present disclosure simplify and speed up the process by using a rule based system.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for managing suppliers and flow of goods on an e-commerce platform implemented by an exemplary embodiment consistent with the present disclosure;

FIG. 2 is another flowchart of a method for managing suppliers and flow of goods on an e-commerce platform implemented by an exemplary embodiment consistent with the present disclosure;

FIG. 3 is another flowchart of a method for managing suppliers and flow of goods on an e-commerce platform implemented by an exemplary embodiment consistent with the present disclosure;

FIG. 4 is an exemplary user interface for managing suppliers and flow of goods consistent with the present disclosure;

FIG. 5 is a schematic diagram of an exemplary system for managing suppliers and flow of goods consistent with the present disclosure;

FIG. 6 is another a schematic diagram of an exemplary system for managing suppliers and flow of goods consistent with the present disclosure;

FIG. 7 illustrates an exemplary operating environment incorporating certain disclosed embodiments; and

FIG. 8 illustrates a block diagram of an exemplary computer system consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

In the present disclosure, a terminal device, a user terminal, and a terminal are used interchangeably to refer to any computing device that may communicate with another computing device. Exemplary user terminals may include a Personal Computer, a Laptop Computer, a smartphone, a tablet computer, etc.

In addition, the supply flow for a product may refer to how one or more suppliers supply a product through an e-commerce platform. For example, if three suppliers supply product A through the e-commerce platform, the supply flows may be 30%, 30%, and 40% respectively. That is, the first supplier may supply 30% of product A; the second supplier may supply another 30% of product A; and the third supplier may supply 40% of product A. A supply mode change may refer to the change of quantity or change of percentage of the supply flow. For example, a supply mode change may be a 10% reduction. That is, the e-commerce platform may reduce the supply flow from the first supplier to 20% of the total supply of product A. The e-commerce platform may then redistribute the supply flow of the three suppliers to 20%, 40%, 40%, respectively. That is, the second supplier may have his supply flow increased to 40% in this example (the supply mode change is a 10% increase).

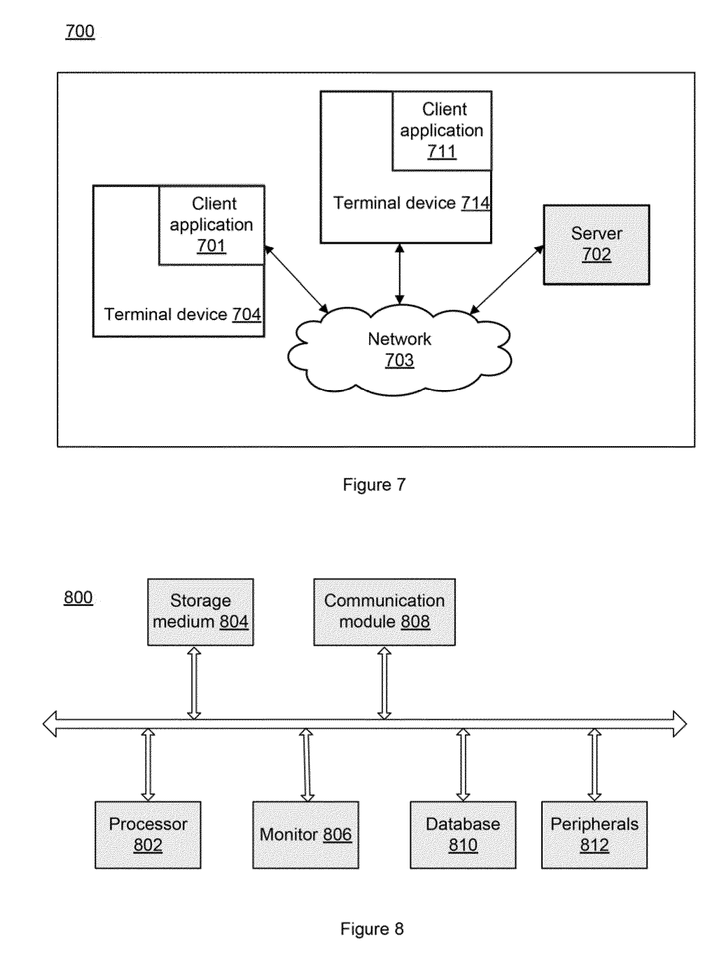

FIG. 7 illustrates an exemplary online computer environment 700 incorporating certain disclosed embodiments. As shown in FIG. 7, environment 700 may include terminal devices 704 and 714, a network 703, and a server 702. The network 703 may include any appropriate type of communication network for providing network connections to the terminal devices 704 and 714, and the server 702. For example, network 703 may include the Internet, LAN (Local Area Network), or other types of computer networks or telecommunication networks, either wired or wireless.

A server 702, as used herein, may refer to one or more server computers configured to provide certain functionalities, which may require any user accessing the services to authenticate to the server before the access. A server 702 may also include one or more processors to execute computer programs in parallel. The server 702 may include any appropriate server computers configured to provide certain server functionalities, such as storing online orders submitted by a user to make online purchases. Although only one server is shown, any number of servers can be included. The server 702 may operate in a cloud or non-cloud computing environment.

Terminal devices 704 and 714 may include any appropriate type of network computing devices, such as PCs, tablets, smartphones, network TVs, etc. Terminal devices 704 and 714 may include one or more client applications 701 and 711. The client applications 701 and 711, as used herein, may include any appropriate software application, hardware application, or a combination thereof to achieve certain client functionalities, such as purchasing products online. For example, client applications 701 and 711 may be the internet explorer application, which may access online shopping websites such as Amazon.com. Any number of client applications 701 and 711 may be included in the environment 700.

In one embodiment, the terminal device 704 may connect to a server 702 to submit online orders. A user may use client application 701 to order a product and send the order to server 702 to complete the purchase. Terminal device 714 may be used by another user, such as a supplier, to communicate with the server 702 to fulfill the order. Terminal device 714 may then receive the request to fulfill an order from the server.

Terminal devices 704/714 and server 702 may be implemented on any appropriate computing platform. FIG. 8 illustrates a block diagram of an exemplary computer system 800 capable of implementing terminal devices 704/714 and server 702.

As shown in FIG. 8, computer system 800 may include a processor 802, storage medium 804, a monitor 806, a communication module 808, a database 810, and peripherals 812. Certain devices may be omitted and other devices may be included.

Processor 802 may include any appropriate processor or processors. Further, processor 802 can include multiple cores for multi-thread or parallel processing. Storage medium 804 may include memory modules, such as Read-only memory (ROM), Random Access Memory (RAM), flash memory modules, and erasable and rewritable memory, and mass storages, such as CD-ROM, U-disk, and hard disk, etc. Storage medium 804 may store computer programs for implementing various processes, when executed by processor 802.

Further, peripherals 812 may include I/O devices such as keyboard and mouse, and communication module 808 may include network devices for establishing connections through the communication network. Database 810 may include one or more databases for storing certain data and for performing certain operations on the stored data, such as database searching.

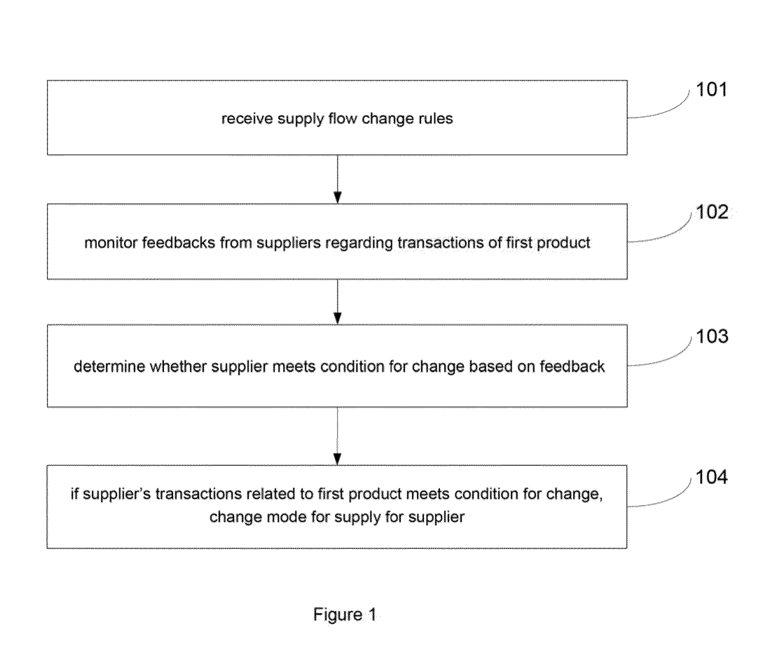

In operation, the terminal device/client application 704/701 may submit to or retrieve data supporting the system for managing suppliers and flow of goods from server 802. FIG. 1 shows a flow chart of a method for managing suppliers and flow of goods implemented by embodiments consistent with the present disclosure. As discussed in relation to FIGS. 7 and 8 above, a system for managing suppliers and flow of goods implementing such a method may include one or more user terminal devices and one or more servers. The user terminal devices may also be referred to as user terminals. The method shown in FIG. 1 includes steps 101-104.

In step 101, a system for managing suppliers and flow of goods may receive or set rules to regulate how products are supplied. The rules regulating the flow of goods may be referred to as supply flow change rules. A supply flow change rule may include a condition for change, and a supply mode change. For example, a supply mode change may be to decrease the flow of a first product from a supplier, or stop the supply of the first product from the supplier (i.e., reduce the flow to zero). The first product may be any product that can be purchased through the e-commerce platform, such as mobile phone prepaid recharge, game currencies, etc. The condition for change may be any condition based on a transaction. For example, a condition for change may be receiving Y out-of-stock messages in X minutes; in X minutes and over Y transactions, (a supplier is) taking more than Z minutes to recharge a mobile phone; or in X minutes, w % of the transactions (from a supplier) being refunded. In addition to these examples, it is apparent that there can be many other conditions for change and supply mode changes. In embodiments consistent with the present disclosure, the system for managing suppliers and flow of goods may change the supply mode of a supplier when it meets the corresponding condition for change and, therefore managing the flow of goods.

In step 102, the system for managing suppliers and flow of goods may monitor the feedbacks from suppliers regarding transactions of the first product. For example, the feedback may be any information about a transaction conducted based on a user's order through the e-commerce platform. The feedback may include, but are not limited to, whether the transaction is successful, the timeliness of the transaction, the quality of the product, etc.

In step 103, based on the feedback information, the system for managing suppliers and flow of goods may determine whether the supplier meets any of the conditions for change. For example, the system may monitor the feedback regarding the transactions of the first product. The system may sum up a certain kind of transactions and compare the sum to a threshold value. In one example, the system may collect all feedbacks about how many out-of-stock messages the supplier has sent within X minutes, and determine whether the number of out-of-stock messages is more than the threshold value.

In step 104, if the supplier's transactions related to the first product meets the condition for change, the system for managing suppliers and flow of goods may change the mode of supply for the supplier. In this example, each condition for change may correspond to one mode change. If the supplier's transaction related to the first product meets a condition for change, the system may adjust the mode of supply according to the corresponding mode change. For example, if the supplier sent Y out-of-stock messages in X minutes, then the system may decrease the supply flow of the first product from the supplier by v %.

Embodiments consistent with the present disclosure provide a method and system for managing suppliers and flow of goods on an e-commerce platform. The system for managing suppliers and flow of goods may receive supply flow change rules and monitor feedbacks from the suppliers regarding transactions related to a first product. A supply flow change rule may include a condition for change and a corresponding change of supply mode. Based on the feedback, the system may determine whether a supplier's offering of the first product meets the condition for change. If so, the system may adjust the flow from the supplier according to the corresponding mode change. Embodiments consistent with the present disclosure therefore effectively use feedback information, automate the management of the flow of goods, and simplify the management process. Instead of manually adjusting the flow of goods on an e-commerce platform, the embodiments consistent with the present disclosure simplify and speed up the process by using a rule based system.

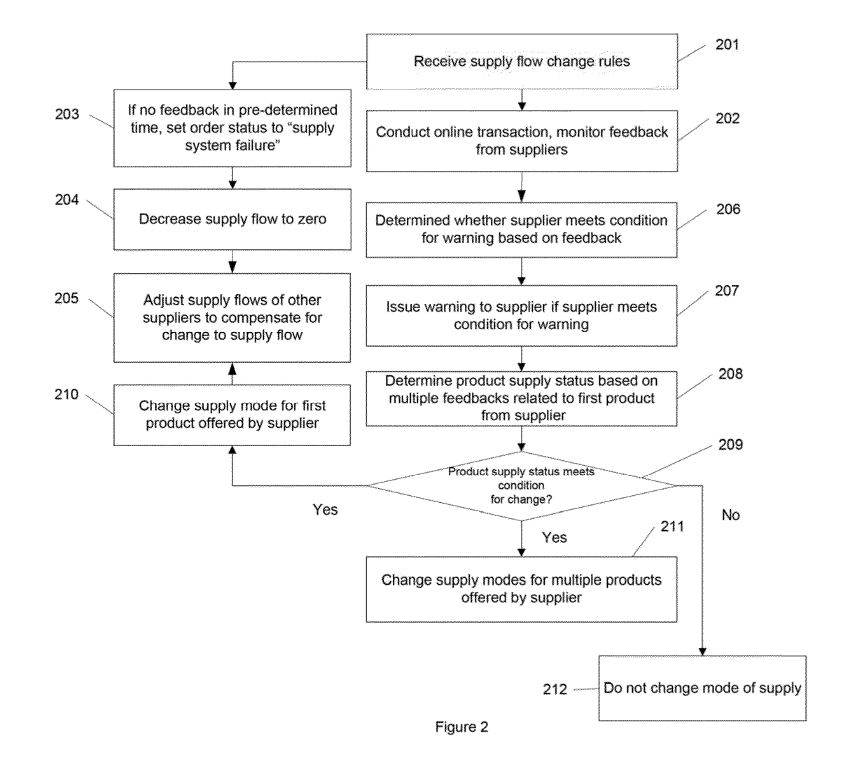

FIG. 2 shows another exemplary method for managing suppliers and flow of goods consistent with the present disclosure. The method shown in FIG. 2 includes steps 201-212.

In step 201, the system for managing suppliers and flow of goods may receive or set rules to regulate how products are supplied. The rules regulating the flow of goods may be referred to as supply flow change rules. A supply flow change rule may include a condition for change, and a supply mode change. For example, a supply mode change may be to decrease the flow of a first product from a supplier, or stop the supply of the first product from the supplier (i.e., reduce the flow to zero). The first product may be any product that can be purchased through the e-commerce platform, such as mobile phone prepaid recharge, game currencies, etc. The condition for change may be any condition based on a transaction. For example, a condition for change may be receiving Y out-of-stock messages in X minutes; in X minutes and over Y transactions, (a supplier) taking more than Z minutes to recharge a mobile phone; or in X minutes, w % of the transactions (sent to a supplier) being refunded. In addition to these examples, it is apparent that there can be many other conditions for change and supply mode changes. In embodiments consistent with the present disclosure, the system for managing suppliers and flow of goods may change the supply mode of a supplier when it meets the corresponding condition for change and, therefore managing the flow of goods.

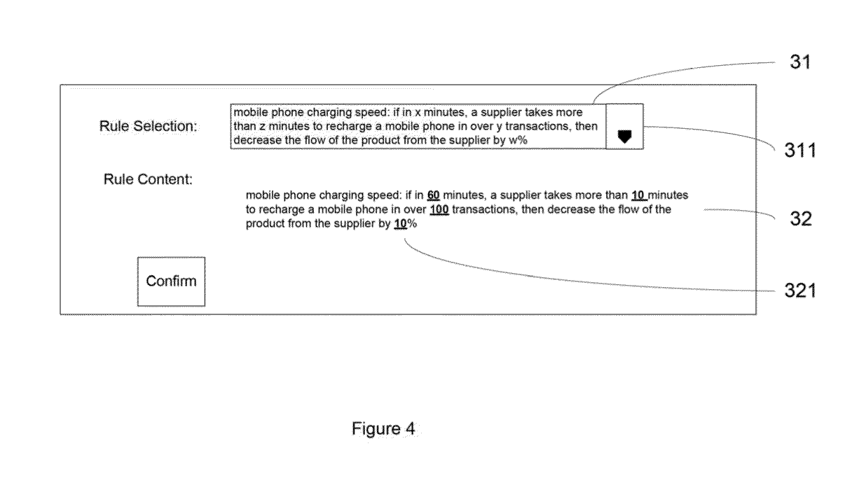

FIG. 4 shows an exemplary user interface that a user can use to enter the supply flow change rules consistent with the present disclosure. In FIG. 4, the user interface may include a rule selection area 31, which may provide templates of supply flow change rules. As shown in FIG. 4, one supply flow change rule may be “mobile phone charging speed: if in x minutes, a supplier takes more than z minutes to recharge a mobile phone in over y transactions, then decrease the flow of the product from the supplier by w %.” The rule selection area 31 may include a pull down menu. When a user clicks button 311, then the user interface may display multiple supply flow change rule templates. Once the user selects a rule template, he may enter the parameters for the selected supply flow change rule in the rule content area 32. As shown in FIG. 4, the value of x, y, z, and w, may be specified in the rule content area 31 through the data entry fields 321. In FIG. 4, the user enters a rule: “mobile phone charging speed: if in 60 minutes, a supplier takes more than 10 minutes to recharge a mobile phone in over 100 transactions, then decrease the flow of the product from the supplier by 10%.”

In step 202, the e-commerce platform may facilitate online purchases. The system for managing suppliers and flow of goods may monitor the feedbacks from suppliers regarding transactions of the first product. After step 202, the system may execute step 206. For example, the feedback may be any information about a transaction that has been conducted based on a user's order through the e-commerce platform. The feedback may include, but are not limited to, whether the transaction is successful, the timeliness of transaction, the quality of the goods, etc.

In step 203, if the system for managing suppliers and flow of goods does not receive any feedback from a supplier, the system may determine that there is a supply system failure. That is, after the e-commerce platform sends an order to a supplier, if the supplier does not send a feedback within a pre-determined time, then the system for managing suppliers and flow of goods may determine that the supplier has a supply system failure. For example, after the e-commerce platform sends an order to a supplier, if the supplier does not send a feedback within 10 minutes, then the system for managing suppliers and flow of goods may determine that the supplier has a supply system failure.

In step 204, the system for managing suppliers and flow of goods may decrease the flow of the first product from the supplier to zero. That is, after the system determines that the supplier has a supply system failure, it may reduce the flow from the supplier to zero.

In step 205, after adjusting the supply flow of the supplier, the system for managing suppliers and flow of goods may adjust the weight ratio for the flow of goods for other suppliers so that the first product is sufficiently supplied by the suppliers. In one example, if one supplier's mode of supply for the first product is reduced by 10%, the system for managing suppliers and flow of goods may adjust the supply flow from the other suppliers to compensate for this reduction. For example, the system may evenly distribute the reduced 10% flow to the other suppliers. In another example, the system may adjust the flow of the other suppliers based on the quality of their first products and the quality of their services. The suppliers with fast delivery and better product quality may be assigned a higher weight ratio (to supply more goods).

In step 206, the system for managing suppliers and flow of goods may determine whether the offering of the first product from a supplier meets a condition for warning. For example, a condition for warning may be receiving Y out-of-stock messages in X minutes; in X minutes and over Y transactions, taking more than Z minutes to recharge a mobile phone; or in X minutes, w % of the transactions being refunded. A condition for warning may be similar to a condition for change. Often the condition for warning sets lower threshold values. Thus, a supplier may meet the condition for warning before it meets the condition for change.

In step 207, if the supplier meets the condition for warning, the system for managing suppliers and flow of goods may send a warning to the supplier. For example, the system may send a text message or a voice message to warn the supplier.

In step 208, based on the feedback messages from the supplier, the system for managing suppliers and flow of goods may determine the product supply status. The product supply status may be determined based on information from a number of orders, or multiple order status messages related to a product. For example, the product supply status may be “normal” or “supply system failure.”

In step 209, the system for managing suppliers and flow of goods may determine whether product supply status of the supplier meets the condition for change. If so, the system may execute step 210 or step 211. If not, the system may execute step 212. For example, the system for managing suppliers and flow of goods may determine whether product supply status of the supplier meets the condition for change based on one or more feedback messages from the supplier. The system may sum up a certain kind of transactions and compare the sum to a threshold value. In one example, the system may collect all feedbacks about the supplier sending out-of-stock messages within X minutes, and determine whether the number of out-of-stock messages is more than the threshold value.

In step 210, the system for managing suppliers and flow of goods may change the supplier's mode of supply for the first product based on the values set in the supply flow change rule, such as those entered in FIG. 4. In step 211, the system for managing suppliers and flow of goods may change the supplier's mode of supply for the multiple products based on the values set in the supply flow change rule.

In some embodiments, a condition for change may correspond to a mode change. When a supplier meets the condition for change, the system may change the supply modes of multiple products. For example, if the supplier sent Y out-of-stock messages in X minutes, then the system may decrease the supply flow of the one product from the supplier by v %. In these embodiments, if the supplier meets the condition for change for the first product, the system may change the supply mode of multiple products supplied by the supplier.

In step 212, the system for managing suppliers and flow of goods may choose not to change the supplier's mode of supply for the first product. For example, if the product supply status does not meet the condition for change, the system may keep monitoring the feedback from the suppliers.

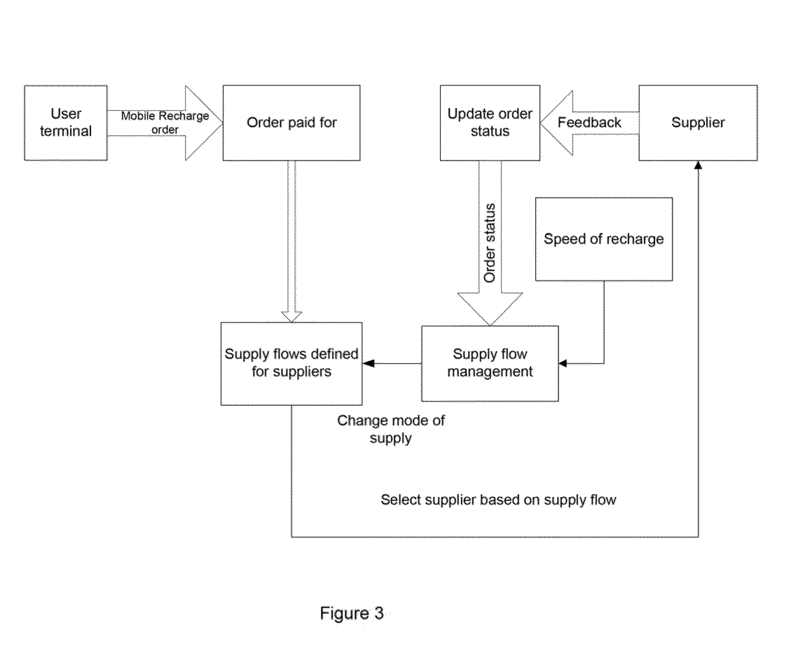

FIG. 3 shows a flow chart of a method for managing suppliers and flow of goods consistent with the method described in steps 201-212 of FIG. 2. In FIG. 3, for example, a user may submit an order through a user terminal to recharge his mobile phone. After the order is received by the e-commerce platform, system for managing suppliers and flow of goods may be engaged to fulfill the order. They system may then fulfill the order based on the flow of supply defined or each supplier. After a supplier receives the order from the system for managing suppliers and flow of goods, it may fulfill the order and provide feedback to the system. The order status may be set to “complete” when the mobile phone recharged is completed. Based on the feedback, the system for managing suppliers and flow of goods may determine whether the condition for change is met by using a method such as the one described in relation to FIG. 2. If the condition for change is met, the system for managing suppliers and flow of goods may change the mode of supply of the supplier.

Embodiments consistent with the present disclosure provide a method and system for managing suppliers and flow of goods on an e-commerce platform. The system for managing suppliers and flow of goods may receive supply flow change rules and monitor feedbacks from the suppliers regarding transactions related to a first product. A supply flow change rule may include a condition for change and a corresponding change of supply mode. Based on the feedback, the system may determine whether a supplier's offering of the first product meets the condition for change. If so, the system may adjust the flow from the supplier according to the corresponding mode change. Embodiments consistent with the present disclosure therefore effectively use feedback information, automate the management of the flow of goods, and simplify the management process. Instead of manually adjusting the flow of goods on an e-commerce platform, the embodiments consistent with the present disclosure simplify and speed up the process by using a rule based system.

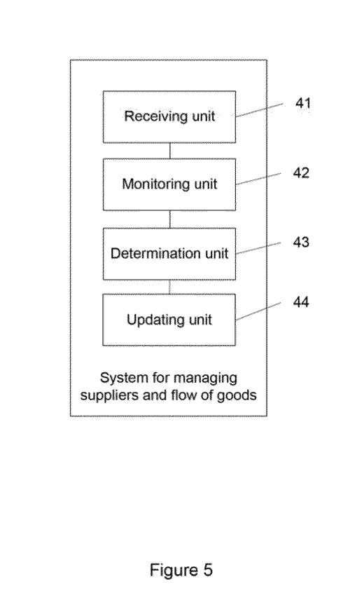

FIG. 5 shows an exemplary system for managing suppliers and flow of goods consistent with the present disclosure. The system may include a receiving unit 41, a monitoring unit 42, a determination unit 43, and an updating unit 44.

The receiving unit 41 may receive supply flow change rules. A supply flow change rule may include a condition for change and a corresponding change of supply mode. The monitoring unit 42 may monitor feedback from suppliers for products supplies. The determination unit 43 may determine whether a supplier meets a condition for change based on the feedbacks monitored by the monitoring unit 42. The updating unit 44 may change the mode of supply for the supplier if the determination unit 43 determines that the supplier meets the condition for change. FIG. 1 shows an exemplary method for managing supply flows using these functional units, which is not repeated here.

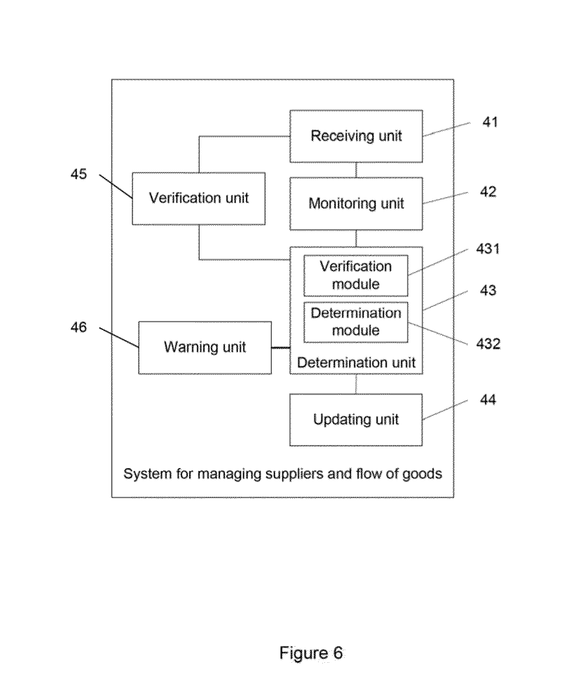

FIG. 6 also shows an exemplary system for managing suppliers and flow of goods consistent with the present disclosure. The system includes a receiving unit 41, a monitoring unit 42, a determination unit 43, and an updating unit 44. In addition, the system includes a verification unit 45, a warning unit 46, a verification module 431, and a determination module 432.

As described above, the system for managing suppliers and flow of goods may change the mode of supply for a supplier if the supplier meets the condition for change for a first product. Specifically, the verification module 431 may determine the product supply status of the first product based on the feedback data accumulated by the monitoring unit 42. The determination module 432 may determine whether the first product's product supply status meets the condition for change. The verification unit 45 may determine that there is a supply system failure when the monitoring unit 42 had not received any feedback from the supplier regarding the first product in a pre-determined time period. The updating unit 44 may reduce the supply flow from the supplier of the first product to zero.

The updating unit 44 may change the mode of supply for the supplier if the determination unit 43 determines that the supplier meets the condition for change. The updating unit 44 may change the supply flow for the first product as well as the supply flows for other products. Further, after the system for managing suppliers and flow of goods changes the supply flow of the first product from the supplier, it may redistribute the supply flow of the first product among the suppliers.

The determination unit 43 may also determine whether a supplier meets a condition for warning based on the feedbacks monitored by the monitoring unit 42. If so, the warning unit 46 may send a warning message to the supplier. FIG. 2, in steps 201-202, shows the functions implemented by these functional units, which is not repeated here.

Consistent with embodiments of the present disclosure, one or more non-transitory storage medium storing a computer program are provided to implement the system and method for managing suppliers and flow of goods. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for managing suppliers and flow of goods may be implemented. For example, a system for managing suppliers and flow of goods may select its suppliers based on feedback messages received from the customers, suppliers, and system administrators. After the users order a first product online and fulfill the order, they may send feedback messages about the transactions to the system. After the orders of the first products are fulfilled by one or more suppliers, the suppliers may send feedback messages about the transactions to the system. In addition, when the system sends a warning message or other maintenance messages to suppliers regarding the first product (e.g., low inventory, outdated web pages, etc.), the system administrator may send feedback messages to the system. The system may then determine the product supply status for the first product based on the feedbacks received from all three sources, and possibly other sources.

For example, one condition for change could be a threshold for warning messages. That is, if a supplier has received x warning messages over a pre-determined time, its mode of supply would be reduced. Alternatively, a condition for change could be a threshold of customer complaints. That is, if a supplier has logged x number of customer complaints over a pre-determined time, its mode of supply would be reduced. Yet in another example, a condition for change may be based on a combination of feedbacks from different sources, such as x number of customer complaints AND y number of supply system failures over a pre-determined time.

Furthermore, the re-distribution of the supply flows after the system reduced the supply flow of one supplier may also be based on the feedbacks received by the system. The system may set up a re-distribution supply flow change rule. The re-distribution supply flow change rule may include conditions for re-distribution (increasing supply flow and decreasing supply flow during re-distribution) similar to the conditions for change. The conditions for redistribution may also correspond to certain mode changes for the supply flow. When the system re-distributes the supply flows, it may check whether a supplier meets a condition for redistribution, and apply the increases and decreases based on the corresponding mode changes. By managing the suppliers using feedbacks from multiple sources, the system may achieve optimal supplier performance and better facilitate online transactions.

What is claimed is:

1. A method for managing suppliers and flow of goods over an e-commerce platform, comprising:
receiving a supply flow change rule, the supply flow change rule includes a condition for change and a supply mode change;
monitoring feedback messages from a supplier regarding transactions associated with a first product;
determining whether the supplier meets the condition for change with regard to the transactions associated with the first product based on the feedback messages; and
changing supply mode for the first product based on the supply mode change if the supplier meets the condition for change.

2. The method according to claim 1, further comprising:
decreasing the supply mode of the supplier for the first product if the supplier meets the condition for change.

3. The method according to claim 2, further comprising:
determining a product supply status for the first product based on the feedback messages; and
determining whether the product supply status meets the condition for change.

4. The method according to claims 3, the method further comprising:
determining the product supply status to be supply system failure if no feedback message regarding the first product is received from the supplier over a pre-determined time; and
decreasing the supply mode for the first product from the supplier to 0.

5. The method according to claim 4, the method further comprising:
re-distributing supply flows from suppliers after changing the supply mode of the supplier.

6. The method according to claims 4, the method further comprising:
changing the supply modes for multiple products if the supplier meets the condition for change for the first product.

7. The method according to claims 6, the method further comprising:
determining whether the supplier meets a condition for warning regarding the transactions associated with the first product; and
issuing a warning message if the supplier meets the condition for warning.

8. A system for managing suppliers and flow of goods over an e-commerce platform, comprising:
a receiving unit configured to receive a supply flow change rule, the supply flow change rule includes a condition for change and a supply mode change;
a monitoring unit configured to monitor feedback messages from a supplier regarding transactions associated with a first product;
a determination unit configured to determine whether the supplier meets the condition for change with regard to the transactions associated with the first product; and
an updating unit configured to change supply mode for the first product based on the supply mode change if the supplier meets the condition for change.

9. The system according to claim 8, wherein the updating unit decreases the supply mode of the supplier for the first product if the supplier meets the condition for change.

10. The system according to claim 9, wherein the determination unit determines a product supply status for the first product based on the feedback messages; and determines whether the product supply status meets the condition for change.

11. The system according to claim 10, wherein the determination unit determines the product supply status to be supply system failure if no feedback message regarding the first product is received from the supplier over a pre-determined time; and decreases the supply mode for the first product from the supplier to 0.

12. The system according to claim 11, wherein the updating unit re-distributes supply flows from suppliers after changing the supply mode of the supplier.

13. The system according to claims 11, wherein the updating unit changes the supply modes for multiple products if the supplier meets the condition for change for the first product.

14. The system according to claims 13, wherein the determination unit determines whether the supplier meets a condition for warning regarding the transactions associated with the first product.

15. The system according to claims 14, further comprising:
a warning unit configured to issue a warning message if the supplier meets the condition for warning.

16. A system for managing suppliers and flow of goods over an e-commerce platform, comprising:
a receiving unit configured to receive a supply flow change rule, the supply flow change rule includes a condition for change and a supply mode change;
a monitoring unit configured to monitor feedback messages from a supplier, a customer, or a system administrator regarding transactions associated with a first product;
a determination unit configured to determine whether the supplier meets the condition for change with regard to the transaction associated with the first product based on the feedback messages; and
an updating unit configured to change supply mode for the first product based on the supply mode change if the supplier meets the condition for change.

17. The system according to claim 16, wherein:
the receiving unit is further configured to receive a re-distribution supply flow change rule, the re-distribution supply flow change rule includes a condition for re-distribution and a re-distribution supply mode change;
the determination unit is further configured to determine whether suppliers meet the conditions for re-distribution with regard to the transaction associated with the first product; and
the updating unit is further configured to re-distribute supply modes based on whether the suppliers meet the conditions for re-distribution.
